(19) United States
(12) Patent Application Publication
(10) Pub. No.: US 2017/0022016 A1
(43) Pub. Date: Jan. 26, 2017

(54) Bulk Bag Design With Pass-Through Forklift Tine Sleeves and Method of Use

(71) Applicant: Potters Industries, LLC, Wilmington, DE (US)

(72) Inventor: Richard James, Victoria (AU)

(21) Appl. No.: 14/808,176

(22) Filed: Jul. 24, 2015

(51) Int. Cl. B65G 65/40; B65G 53/26; B65G 69/06; B66F 9/06; B65D 88/16; B65G 65/00

(52) U.S. Cl. CPC B65G 65/40; B65D 88/1687; B65D 88/1612; B65G 65/00; B65G 69/06; B66F 9/06; B65G 53/26

(57) ABSTRACT

A bag configured to contain and transport bulk material includes at least one through-hole positioned at an upper portion of the bag to facilitate ingress/egress of a hoist-member of a hoisting machine. Other embodiments include a spout located at a bottom-side portion of the bag or at a base of the bag, and inserts placed at a base of the bag to form a desired contour to generate a gradient by which the material may flow. The inserts may be temporarily placed at the base or permanently affixed thereto. Further embodiments may include a contoured base without the use of inserts to generate the gradient. Methods of use include stacking and handling the bags without requiring an operator in addition to the one operating the hoisting machine or requiring the hoist machine operator to interrupt operation of the hoist machine to rig the bag to the hoist machine.

### BACKGROUND OF THE INVENTION

Field of the Invention

Embodiments disclosed herein generally relate to methods of using bags, and in particular methods of using bags having forklift tine through-holes.

Background of the Related Art

Many industrial applications include batch processing, in which material integral to the application is added in specified amounts and at specified times. The material is typically added to the process in lots to be consumed/dispensed by the process in a controlled manner. Generally, the material is held in bags, where each bag may comprise a lot. When added to the process, the bags are either consumed by the process or removed from the process to be subsequently discarded or reused. For instance, in steelmaking operations, bags of mineral additives may be added to a ladle of molten steel to condition slag, where the bags may be consumed by the molten steel. As another example, bags of glass beads may be added to a hopper of a dispensing unit to be projected onto wet paint or another substrate to imbed the glass beads into the substrate, where the bags may be removed after application of the glass beads to be discarded or reused. With such applications, the gross weight of the bag and contained material is generally too much for a human to handle manually in an effective and safe manner. Consequently, machinery, such as forklifts, cranes, and similar hoisting equipment is used to handle the bags by rigging them to a hoist of the machine.

Productivity and safety are constant concerns for industrial applications. Eliminating a process step, in particular obviating steps that comprise menial tasks executed by humans, frees up time, energy, and human capital/skill that can be allocated elsewhere. In addition, eliminating process steps generally reduces error, increases throughput, and reduces safety hazards. Yet, existing bags and methods of handling them employ too many process steps. One of the reasons for this deficiency is that existing bags and methods of handling them use a human rigger to rig, or otherwise secure, the bag to the hoist machine. This typically entails the hoist machine operator to interrupt his operations to rig the bag himself or a second operator to perform the rigging.

Obviating the rigging step by a rigger can not only save precious time and enable better allocation of human operators' skills elsewhere in the process, but the probabilities of error and human injury may also be decreased from the mere fact that the number of steps/actions to be performed has been reduced. Furthermore, with existing bags and methods, if the bag should have to be removed from the process before the material is fully consumed/dispensed for any reason, an operator must again rig the bag to the hoist machine. This generates a significant safety hazard because the rigger must position himself near moving parts that may be energized.

### BRIEF SUMMARY OF THE INVENTION

The apparatus includes a bag configured to contain and transport bulk material, such as glass beads, lime, carbon, flux, or other industrial additives and burden. The bag may include at least one through-hole positioned at an upper portion of the bag to facilitate ingress/egress of a hoist-member of a hoisting machine (e.g., a forklift tine of a forklift). Other embodiments may include a spout located at a bottom-side portion of the bag or at a base (e.g., underneath) of the bag to serve as a bulk dumping point of the bag. Further embodiments may include at least one base insert placed at a base of the bag to form a desired contour, thus generating a gradient by which the material may flow.

The bags may be stacked in an efficient and space-saving manner for storage purposes, for example, without requiring ancillary pallets or pallecons that take up space, add weight to the freight, and/or make handling more complicated. When removing the bag from its storage area/facility (e.g., a flatbed truck, a warehouse floor, a marshaling yard, etc.), the forklift operator may simply insert the tines into the through-holes of the bag, hoist the bag from storage, and place the bag into a dispensing unit container (e.g., a hopper) without requiring the assistance of a second operator (e.g., rigger or spotter) to ensure the tine engages with the bag for hoisting.

As by way of example, the bags may be used in an operation to dispense glass beads onto a surface, such as a painted road line. A method of using the bags filled with glass beads may include using a forklift to place at least one bag on a flatbed of a truck by stacking them upon each other in an organized, efficient, and space-saving manner to be transported to the worksite. The bags may then be transported from the stacked formation via the forklift by simply inserting the tines into the through-holes of a bag to hoist and transport it to a hopper of a dispensing unit. The forklift operator may lower the bag into the hopper and extract the tines from the through-holes, leaving the bag well-positioned within the hopper. A piercing object may be used to pierce the bag through a port of the hopper to enable free flow of the glass beads through the port. Some embodiments may include the use of a lance to pierce the bag. The lance may be adapted to couple to the port via a coupler assembly, drawing the glass beads via a vacuum to be controllably dispensed by the dispensing unit.

While embodiments of the bag disclosed herein are described and illustrated as being used in industrial settings and batch-style processing, they are certainly not limited to such uses. Any situation that may benefit from the transportation and use of material in a bag-type container may be a practical application of the disclosed apparatus and method of use. Furthermore, hoisting machines other than a forklift may be used, which may include a crane, a derrick, a winch, etc.

While these potential advantages are made possible by technical solutions offered herein, they are not required to be achieved. The presently disclosed apparatus and method of use can be implemented to achieve technical advantages, whether or not these potential advantages, individually or in combination, are sought or achieved.

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages and possible applications of the present invention will be more apparent from the following more particular description thereof, presented in conjunction with the following drawings, in which:

FIG. 1 is a perspective view of the bag showing forklift tines being inserted through aperture-style through-holes;

FIGS. 2A and 2B show the bag being lowered into a hopper of a dispensing unit and various shapes and of the bag to complement a shape of a hopper, respectively;

FIG. 3A shows an alternative embodiment of the bag having corridor-style through-holes, and FIGS. 3B-C show partial views of the bag with through-hole inserts inserted into the bag;

FIGS. 4A and 4B show a side view of the bag with a flared upper portion being stacked on top of another bag and a perspective view of the bag with a flared upper portion;

FIGS. 5A and 5B show a bag with a contoured base and a bag with base inserts, respectively,

FIG. 6 shows a bag with base insert receptacles and an inflatable bladder base insert;

FIGS. 7A and 7B show cut-away perspective views of a sidewall or base with a lance aperture and a sacrificial flap connected by a snap fastener and by adhesive, respectively;

FIGS. 8A and 8B show a hopper with a sump and a cross section of the bag with an extension inside the hopper, respectively;

FIG. 9 shows a bag with a spout extending from an outer surface of the bag;

FIG. 10 shows a lance assembly including an aeration inlet and a suction outlet;

FIG. 11 shows a bag with loops connected to the top of the bag, spanning from one sidewall to a subtending sidewall; and,

FIG. 12 illustrates an exemplary method of using the bag with through-holes.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

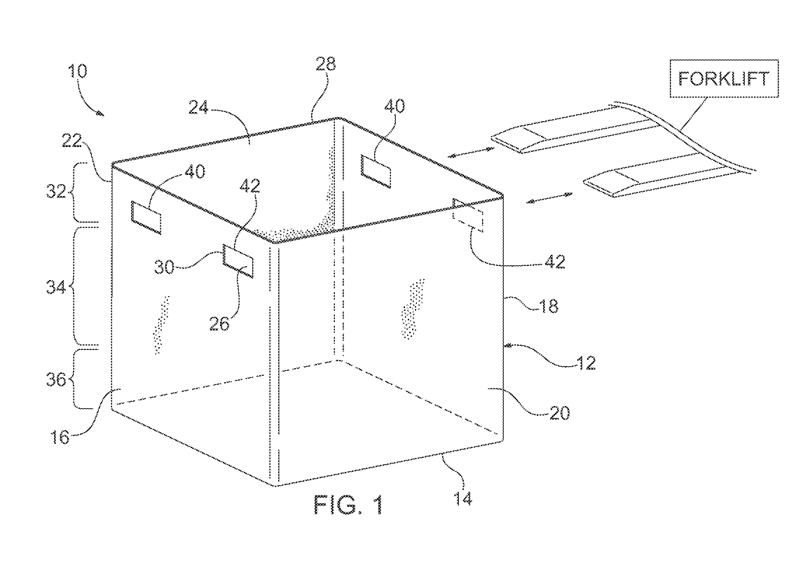

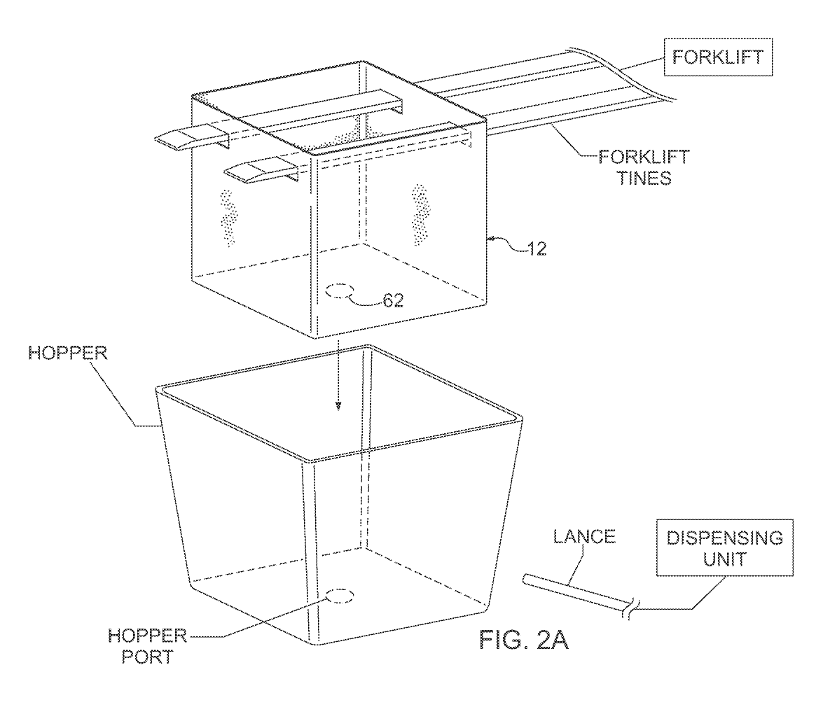

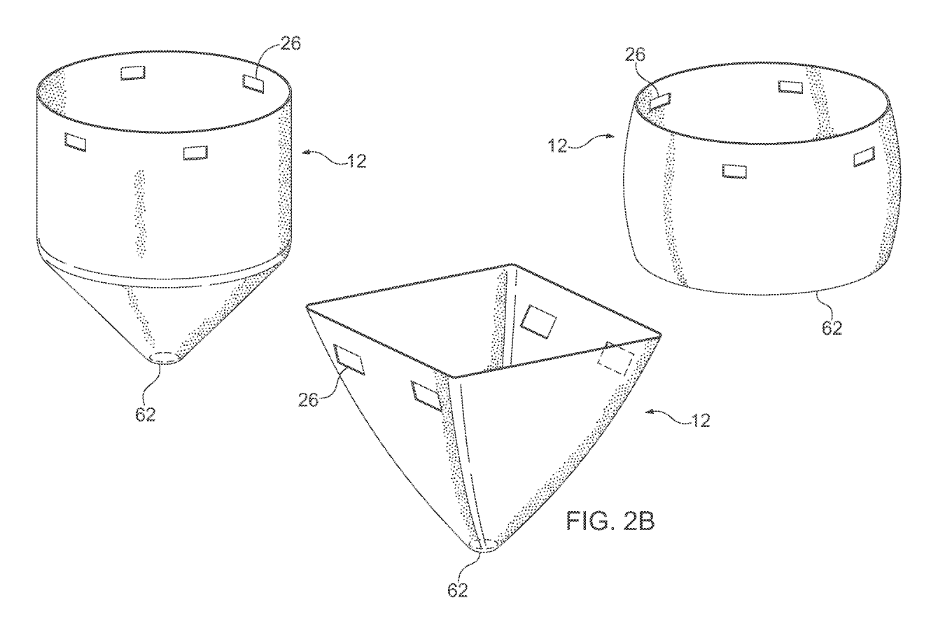

Referring now to FIGS. 1-2B, the apparatus 10 includes a bag 12 having a base 14 conjoined with sidewalls 16, 18, 20, 22 forming a cavity 24, wherein at least one through-hole 26 is formed into the bag 12. The bag 12 may be fabricated from a heavy-duty fabric, such as canvas, nylon, polyester, polyethylene, high-density polyethylene, etc. suitable to withstand loads ranging from 100 pounds to 2 tons, and it may exhibit a variety of shapes, such as spherical, cubic, pyramidal, conical etc. to complement a shape of the hopper and/or enable stacking full bags 12 while in storage (see FIG. 2B). One skilled in the art will appreciate, with the benefit of the present disclosure, that the bag 12 may be fabricated to support other weights and loads for which a particular process may require. The bag 12 may also be fabricated from a water-resistant fabric and/or may be provided with a flexible liner (e.g., polyethylene, high-density polyethylene) to provide water resistance.

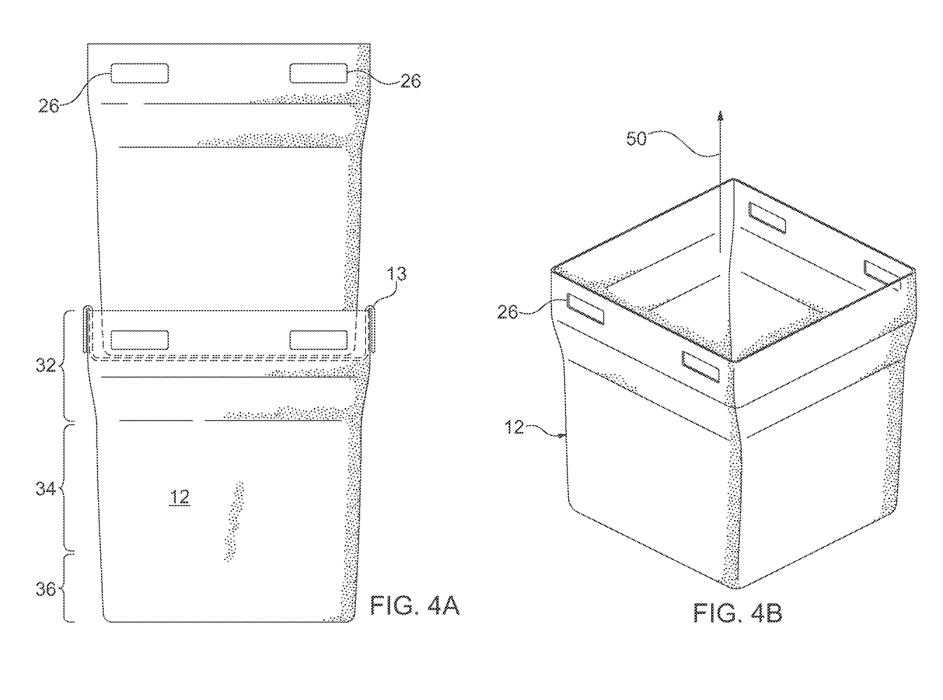

As illustrated in FIG. 1, the bag 12 may have a general cubic shape with a base 14, four conjoining sidewalls 16, 18, 20, 22, and an open top 28. A top-cover 13 may also be conjoined to the sidewalls 16, 18, 20, 22 or even removably secured to the top 28 of the bag 12 via a zipper, snap-fastener, hook-and-pull fastener, shrink-wrapping, or similar fastening means (see FIG. 4A). The bag 12 is shown as being fabricated from a unitary piece of fabric, but it may also be constructed from a plurality of fabric panels sewn, or otherwise connected, together. Additionally, the bag 12 may be constructed from a single fabric layer or from multiple layers. Some portions of the bag 12 may include reinforced seems or stitching to provide added support. For instance, corners, a top edge 28, and/or the through-hole rims 30 may have a hem, double stitching, or an extra layer of fabric.

The bag 12 is generally flexible, but portions of the bag 12 may have some rigidity. For instance, an upper portion 32 of the bag 12 may be constructed of fabric, or may include additional fabric panels, that is/are more rigid than the rest of the bag 12 to enable the through-holes 26 to be stiffly positioned so as to not encumber ingress/egress of the tine. The stiffness may enable the upper portion 32 to exhibit a resiliency to bending, folding, and/or deforming such that the upper portion 32 generally remains “upright” to allow ingress/egress of the tine without having to manually position the upper portion 32 and/or through-holes 26. Other portions of the bag 12 may also have rigid/semi-rigid constructions and/or reinforced seems to enable the bag 12 to hold a desired shape.

Each through-hole 26 may be an aperture formed in a sidewall 16, 18, 20, 22 of the bag 12. To accommodate maximizing the fill-capacity of the bag 12, the through-holes 26 may be situated in the upper portion 32; however, they may also be situated at any portion of the sidewall 16, 18, 20, 22. Placing the through-hole 26 at the upper portion 32 may also enable lowering the bag 12 with the forklift into the hopper and properly seating it within the hopper. With the hopper supporting the weight of the bag 12, extraction of the tines from the through-holes 26 can be achieved without any interference caused by the forklift tines making contact with the hopper. Through-hole rims 30 may be formed about the circumferential edge of the through-holes 26 by a reinforced seem/stitching, as described above.

As shown in FIG. 1, a through-hole pair 40, 42 may be generated by positioning a through-hole 26 in a sidewall subtending a through-hole 26 in an opposing sidewall so as to be aligned in the same plane as a forklift tine extending there-through. Forklift tines may be tilted, oscillated, and/or spread/narrowed, and a through-hole pair 40, 42 may be similarly skewed/offset. For instance, a through-hole 26 in a sidewall may be at a lower/higher position or in more medial/lateral position than its paring through-hole 26. This may be done to enable suspending the bag 12 askew if the working conditions dictate such an operation.

In an exemplary embodiment, the bag 12 includes four through-holes 26. A first pair of through-holes 40 comprises a first through-hole 26 in a first sidewall 16 and a second through-hole 26 in a second sidewall 18. A second pair of through-holes 42 comprises a third through-hole 26 in the first sidewall 16 and a fourth through-hole 26 in the second sidewall 18. The first pair of through-holes 40 may be situated at an upper lateral portion of the bag 12, whereas the second pair of through-holes 42 may be situated at an upper, yet opposing, lateral portion of the bag 12. More or less through-holes 26 may be included. Furthermore, through-holes 26 may be situated in a third and/or fourth sidewall 20, 22 as well. This may be done to enable handling the bag 12, regardless of which side is exposed to the forklift operator. In addition, if a through-hole 26 becomes damaged or otherwise inoperable, a forklift operator may use an alternate pair of through-holes 26.

The through-holes 26 may be circular, rectangular, triangular, or any other shape. Furthermore, each through-hole 26 may have the same shape/size or different shape/size as another through-hole 26. The shapes and sizes may be chosen to accommodate the hoist-member of the hoisting machine used to manipulate and handle the bags 12. For instance, a through-hole 26 may have a generally rectangular shape to complement that of a forklift tine.

In alternative embodiments, such as shown in FIG. 2A, the bag 12 may include lance aperture 62 located at the base 14 to facilitate insertion of the lance without piercing a hole into the bag 12. While it is shown as being located at the base 14, the lance aperture 62 may be located at any portion of the bag 12, such as on a bottom portion 36 for example. Piercing the bag 12 would generally require a user to discard the bag 12 and/or recondition the bag 12 for multiple uses, but with the lance aperture 62 the bag 12 may be reused without reconditioning. In this embodiment, the bag 12 may be provided with a liner, such as a plastic bag for example, placed in an interior of the bag 12 before being filled with material. Inserting the lance through the lance aperture 62 would pierce the liner, after which the liner may be discarded and replaced so that the bag 12 can be reused multiple times.

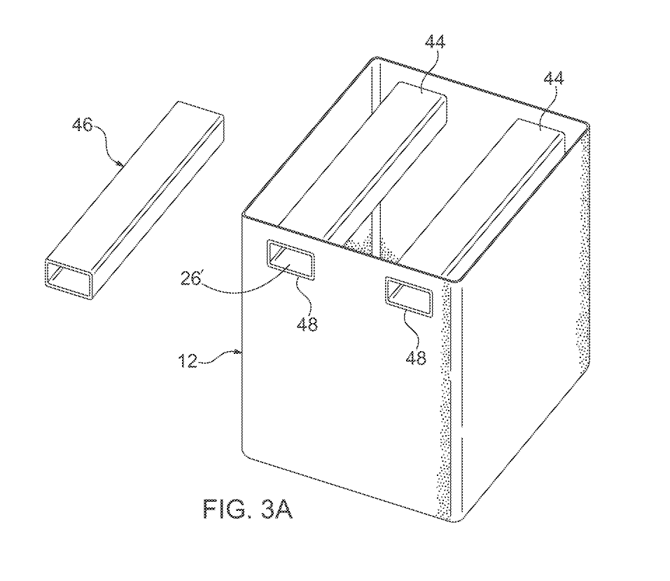

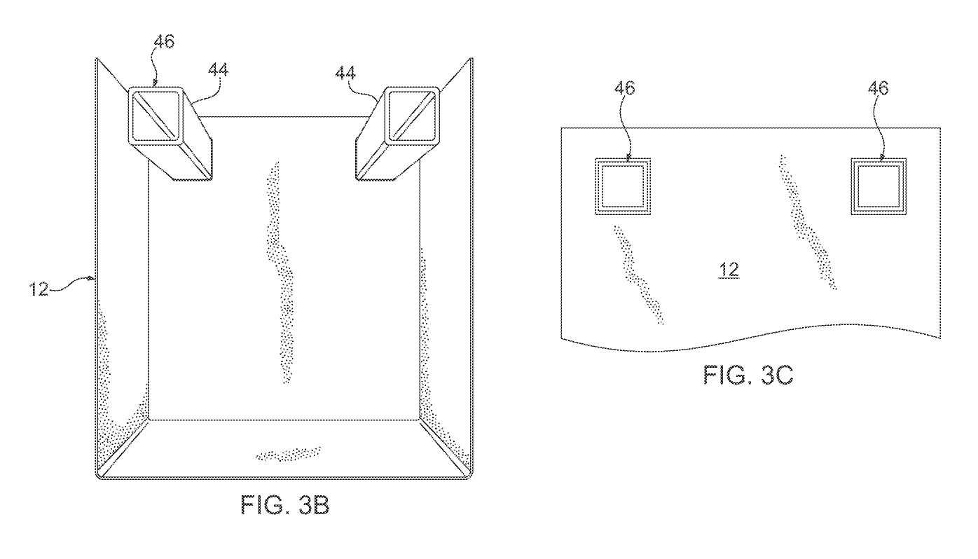

Referring now to FIG. 3A, an alternative embodiment of the bag 12 having corridor-style through-holes 26′ is disclosed.

In addition, or in the alternative, a pair of through-holes 40, 42 may include an enclosed section such that a path between pairing through-holes 40, 42 forms an enclosed corridor 44 within the cavity 24 of the bag 12, generating a corridor-style through-hole 26′ as opposed to the aperture-style through-hole 26 described above. The enclosed corridor 44 may be fabricated from the same fabric as that of the bag 12. The enclosed corridor 44 may also be fabricated from a more rigid material to assist with stiffly holding the through-holes 26′ in position for easy ingress/egress of tines. Through-hole rims 30 of the corridor-style through-hole 26′ may be similarly configured with the reinforced seems/stitching, as described above for the aperture-style through-holes 26.

In situations where the tines cannot be extended all the way through to the subtending aperture-style through-hole 26, the corridor-style through-holes 26′ may facilitate hoisting and maneuvering the bag 12 because the tines would not have to extend throughout the bag 12. For instance, if the forklift tine is too short, if the forklift cannot advance towards the bag far enough due to the working conditions, and/or if the bag 12 had been stacked such that introducing the tine through both pairing aperture-style through-holes 26 is difficult/impossible, then the corridor-style through-hole 26′ would still enable hoisting the bag 12 because the enclosed corridors 44 would provide the support for the partially inserted tines to lift and handle the bag 12.

Whether the through-holes 26 are aperture-style or corridor-style, they may be configured to receive a through-hole insert 46. FIG. 3B shows a cut-away interior view of the bag 12 with through-hole inserts 46 extending through each through-hole 26. FIG. 3C shows a partial side view of the bag 12 with the through-hole inserts 46 inserted in each through-hole 26. The through-hole insert 46 may be, but is not limited to, a pipe, a guide channel, steel member, cardboard, timber, etc., and may be inserted temporarily or permanently. This may be done to provide more rigidity, provide additional load suspending support, and/or provide abrasion and wear resistance to the through-hole rims 30 and/or enclosed corridors 44. In addition, an annulus 48 or ring may be disposed around the through-hole rims 30 for additional abrasion and wear resistance. The through-hole insert 46 and/or annulus 48 may comprise cardboard, metal, plastic, rubber, etc. In addition, the inner surfaces of the through-hole insert 46 and/or annulus 48 may be provided with a nonslip coating/surface. This may include a textured surface or a coating to increase the friction coefficient between the forklift tine and the through-hole insert 46 and/or annulus 48.

Referring now to FIGS. 4A and 4B, a side view of the bag 12 with a flared upper portion 32 being stacked on top of another bag 12, and a perspective view of the bag 12 with a flared upper portion 32 are disclosed.

The inner perimeter of the upper portion 32 may be greater than the outer perimeter of the base 14 and/or main body 34 of the bag 12. This may be achieved by configuring the bag 12 to exhibit a flare, taper, and/or a step in a radial direction away from the longitudinal axis 50 of the bag 12 at the upper portion 32. This configuration may enable stacking filled bags 12 on top of each other. As the base 14 of each stacked bag 12 slides into the cavity 24 at the top 28 of the bag 12 beneath it, the base 14 rests upon the material in the lower bag 12. With the larger opening at the top 28 and the upright, flared stance of the upper portion 32, each bag 12 can be stacked without deforming the upper portion 32 of the bag 12 below it. In addition, rigidity/semi-rigidity may be introduced into the upper portion 32, as described earlier, to enable the upper portion 32 to stand erect when the bag 12 is filled with material. Thus, each stacked bags' upper portion 32 maintains a salutary positioning of the through-holes 26 for quick and easy ingress/egress of the forklift tines without the need of a second operator to rig the bag 12 to the tines. As shown in FIG. 4A, a partial cut-away view reveals that the bags 12 may be stacked such that the base 14 of a bag 12 rests upon the top-cover 13 of the bag 12 beneath it, as opposed to directly on the material held within the bag 12.

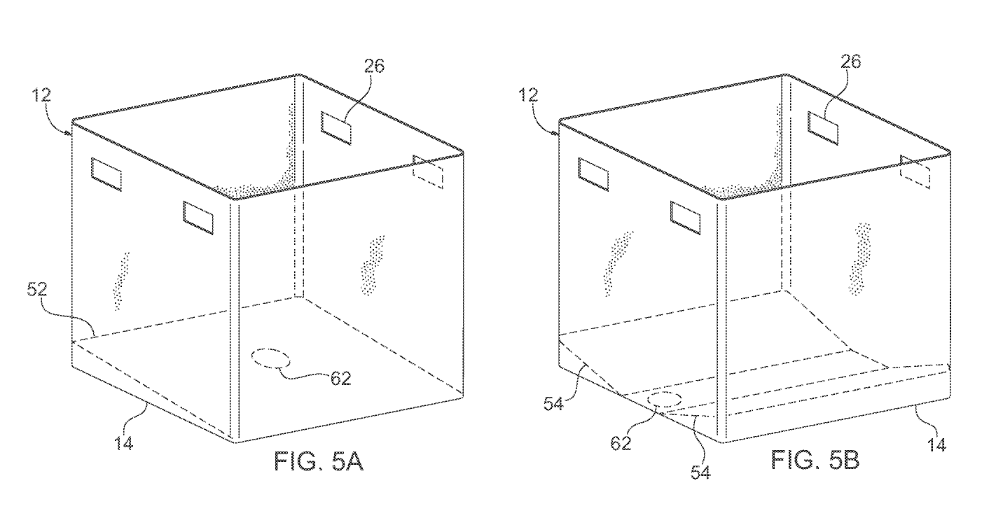

Referring now to FIGS. 5A and 5B, a bag 12 with a contoured base 52, and a bag 12 with base inserts 54 are disclosed.

In alternative embodiments, the base 14 of the bag 12 may have a contour 52 so as to generate a gradient along an interior surface of the base 14 towards a desired direction. For instance, a gradient may be made towards a sidewall 16, 18, 20, 22, assisting with flow of the glass beads or other material towards the sidewall 16, 18, 20, 22 after the bag 12 has been inserted into the hopper and pierced in the same sidewall 16, 18, 20, 22. As another example, a gradient may be made toward a lance aperture 62 formed in a portion of the base 14. The gradient generated by the contoured base 14 may be particularly beneficial for bags 12 that do not have a base 14 (e.g., a conical shaped bag). This may be achieved by increasing the thickness of a portion of the base 14 to generate a funnel/guide towards the sidewall 16, 18, 20, 22, as shown in FIG. 5A. Alternatively, base inserts 54 may be positioned along the base 14 to create the funnel/guide. The base inserts 54 may have an elongated triangular shape with an inclined top surface ascending toward a lance aperture in the base 14; however, other shapes may be utilized. The base inserts 54 may be temporarily placed at the base 14 or permanently affixed thereto (e.g., sewing or molded). Generally, the gradient formed by the base insert 54 would direct the flow of the material toward the sidewall 16, 18, 20, 22 or base 14 portion to be pierced.

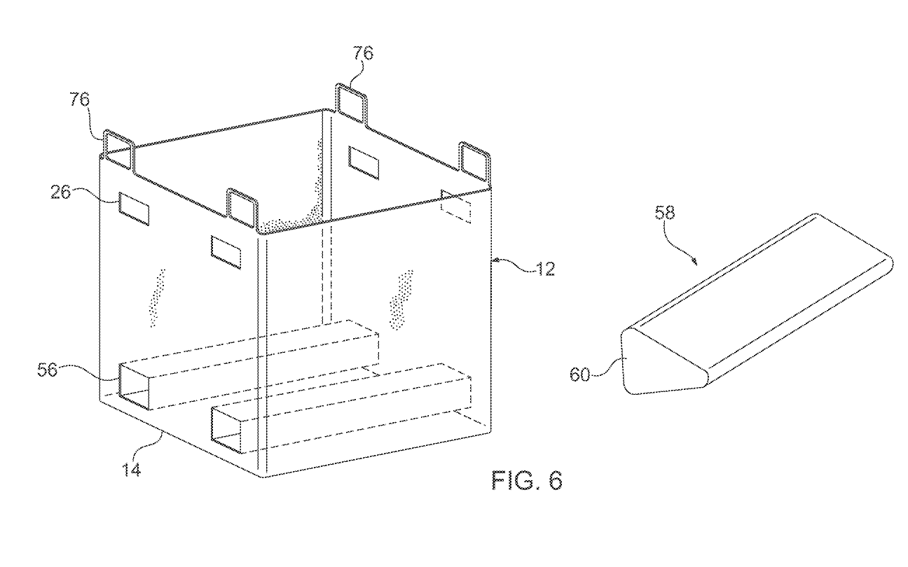

Referring now to FIG. 6, the bag 12 with base insert receptacles 56 and an inflatable bladder base insert 58 are disclosed.

In a further embodiment, the bag 12 may include at least one base insert receptacle 56 located at the base 14 of the bag 12, similarly configured to the corridor-style through-hole 26′ described above, to slidably receive base inserts 54 of various shapes and sizes at the discretion of the user. Generally, the base insert receptacle 56 would be located at the interface of a sidewall 16, 18, 20, 22 and the base 14, and the base insert receptacle 56 would not extend all the way through from one sidewall 16, 18, 20, 22 to another sidewall 16, 18, 20, 22, but would rather form a pocket. However, the base insert receptacle 56 may extend all the way through in some embodiments. Before the bag 12 is filled with glass beads, the user may introduce/remove a base insert 54 to produce a desired contour to the base 14 of the bag 12. The base inserts 54 may be constructed of lightweight durable material suitable to sustain compression loads for a particular application without deforming or crushing. This may include, but is not limited to, cardboard, metal, plastic, foam, rubber, etc.

In an alternative embodiment, the base 14 of the bag 12 may include an inflatable bladder 58 and/or the base insert 54 may be configured as the inflatable bladder 58. With such embodiments, the bladder 58 is provided with a stem valve 60 or similar value to enable selective inflation/deflation of the bladder 58. The stem valve 60 may be accessible from a sidewall 16, 18, 20, 22 portion of the bag 12 and the bladder 58 may be configured to countersink the valve 60 so as to protect the valve 60 from damage when stacking the bags 12 and/or inserting the bag 12 into the hopper.

Alternative embodiments may include at least one loop 76 disposed on a top 28 of the bag 12. Each loop 76 may be a piece of fabric extending from the top edge 28 of a sidewall 16, 18, 20, 22, and may be located at or near a corner of the bag 12. While the loops 76 extend over the top 28 of the bag 12, as opposed to being formed into the sidewall 16, 18, 20, 22, the loops 76 may be positioned to form an aligned pair, as described above with the through-holes 26. The loops 76 may be used in addition, or in the alternative, to the through-holes 26. Generally, the loops 76 may require a second operator to rig the bag 12 to the tines, but the loops 76 may be used in situations where the use of the through-holes 26 may not be applicable (e.g., a through-hole becomes damaged, the bag falls from its stacked position rendering it impracticable to use the through-holes to engage the bag, etc.).

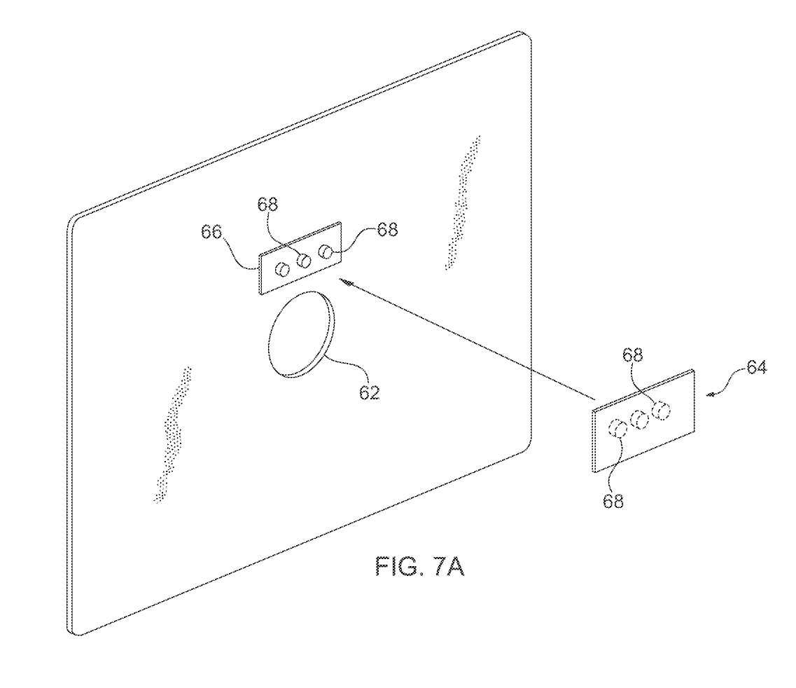

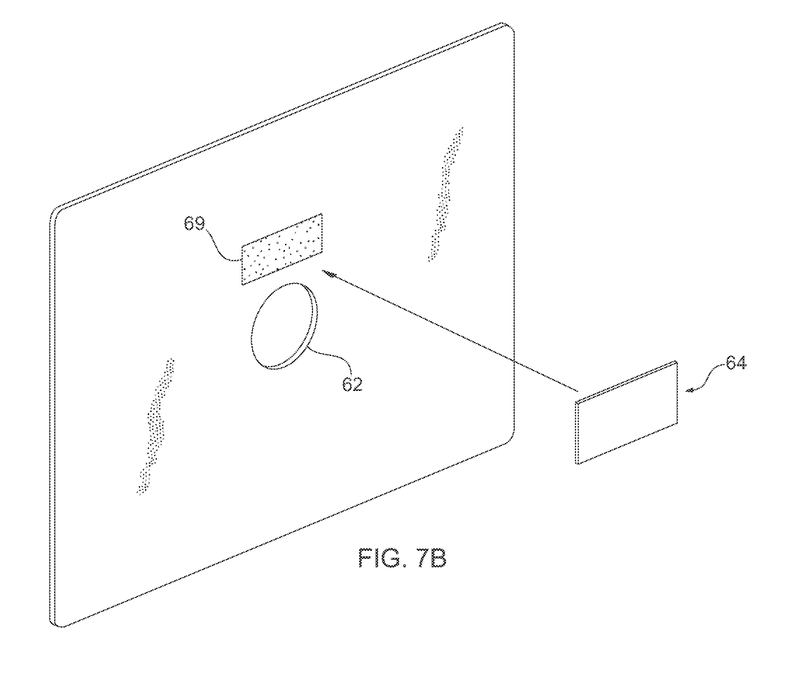

Referring now to FIGS. 7A and 7B, cut-away perspective views of a sidewall 16, 18, 20, 22 or base 14 with a lance aperture 62, a tab 66, and a sacrificial flap 64 are disclosed.

In alternative embodiments, a sacrificial flap 64 may be disposed over the lance aperture 62 to be punctured, discarded, and replaced. For instance, the lance aperture 62 may include a tab 66 stitched to an interior surface of the bag 12 and positioned just above the lance aperture 62. Before filling the bag 12 with material, a sacrificial flap 64 (e.g., fabric, rubber, flexible plastic, etc.) may be attached to the tab 66 to act as an awning to prevent material from exiting through the lance aperture 62. The tab 66 may include fasteners 68, such as snaps for example, to engage complementary fasteners 68 of the flap 64 and temporarily hold the flap 64 to the tab 66. The bag 12 may then be used by piercing the sacrificial flap 64, after which the pierced flap 64 may be removed to be replaced with an un-pierced flap 64 for repeated use of the bag 12. Additional tabs 66 may be disposed near the lance aperture 62 to provide additional fastening means for the sacrificial flap 64, and the sacrificial flap 64 may include additional complementary fasteners 68 to engage each tab 66. Alternatively, the sacrificial flap 64 may be affixed to an interior surface of the bag 12 via adhesive 69 (see FIG. 7B). Using an adhesive 69 may be done with or without the tab 66. The adhesive 69 may include, but is not limited to, rubber cement, silicon, paste, and/or other bonding agents.

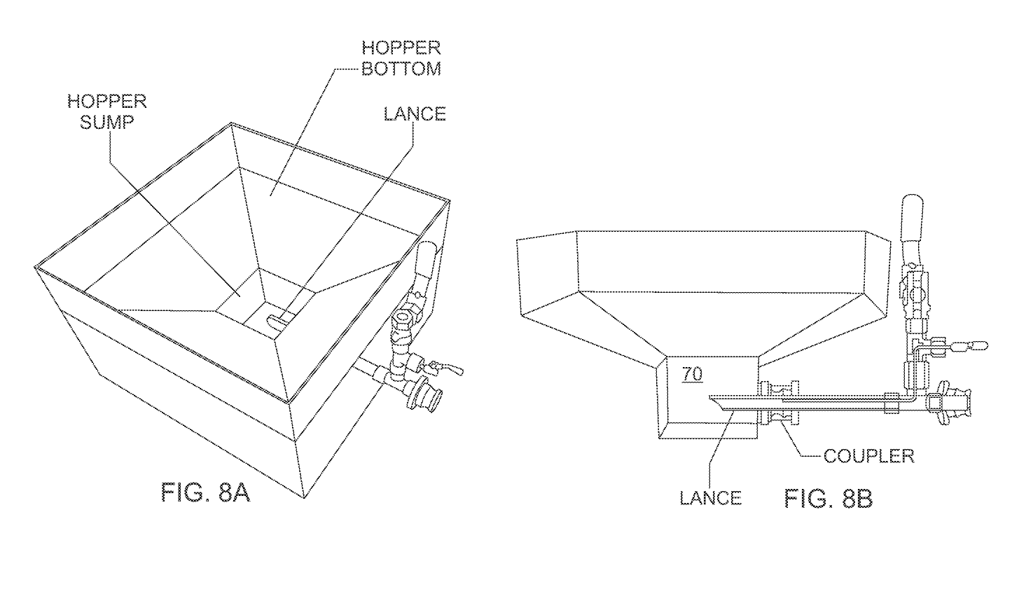

Referring now to FIGS. 8A and 8B, a hopper with a sump and a cross section of a bag 12 with an extension 70 placed inside the hopper, respectively, are disclosed.

An extension 70 may be formed on the base 14 to facilitate a more conforming fit within the hopper as the bag 12 is placed in the hopper. Some hoppers are formed with a sump portion so a bag 12 having the extension 70 enables the bag 14 to seat properly within the hopper by extending into the sump while the remaining portion of the base 14 rests along the bottom of the hopper. With such embodiments the hopper port may be located on the sump portion of the hopper or the bottom, thus the lance may pierce the bag at the extension 70, as well as at a bottom 36 or base 14. Similarly, the lance aperture 62 may be positioned at the bottom 36, base 14, and/or extension 71.

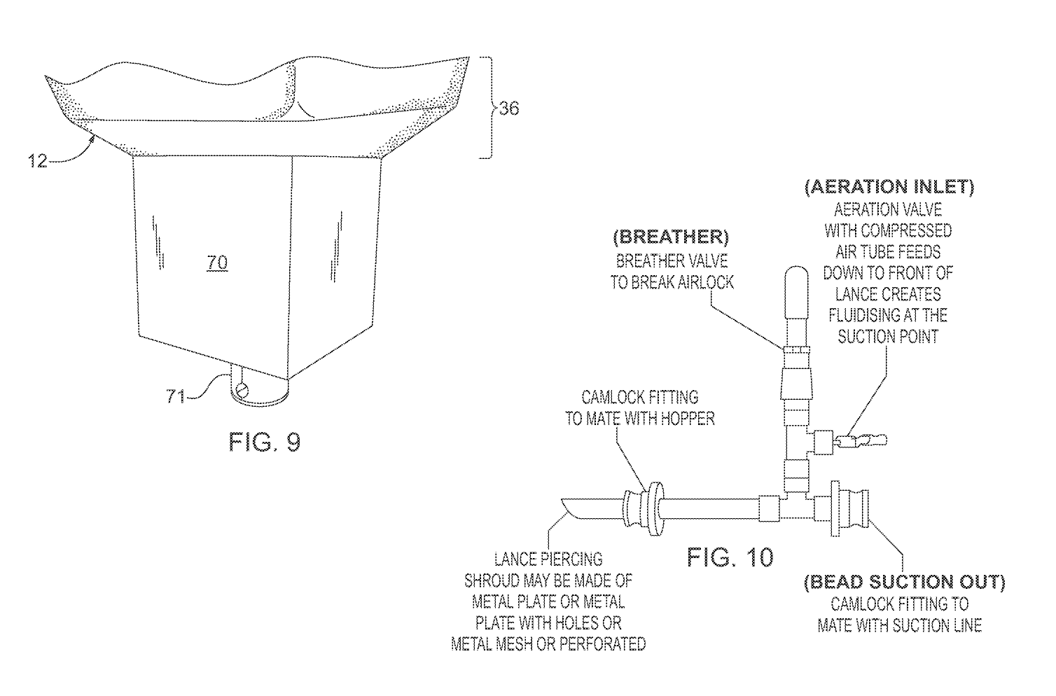

FIG. 9 shows a bag 12 with a spout 71 extending from an outer surface of the bag 12. The spout 71 may be a rigid member or another extension member (similar to the extension 70 described above) of the bag 12. The spout 71 serves as a bulk dumping point of the bag 12 and may be configured to be pierced by the lance. FIG. 9 shows the spout extending from a bottom portion of the extension 70; however, the spout 71 may be positioned anywhere on the bag 12.

FIG. 10 shows a lance assembly including an aeration inlet and a suction outlet in connection with a valve assembly. The inlet is in fluid communication with conduit to direct forced air from an ancillary compressed air source into the bag 12 and cause fluidization of the material within the bag 12. The outlet is in fluid communication with the lance to direct material from the bag via suction provided by the dispensing unit. The valve assembly enables control of flow through the inlet and outlet. The valve assembly further enables air to be directed in through the inlet while material is simultaneously being drawing from the outlet. In use, the compressed air may be used to fluidize and aerate the material in the bag 12 so that drawing the material via suction is achieved unabated.

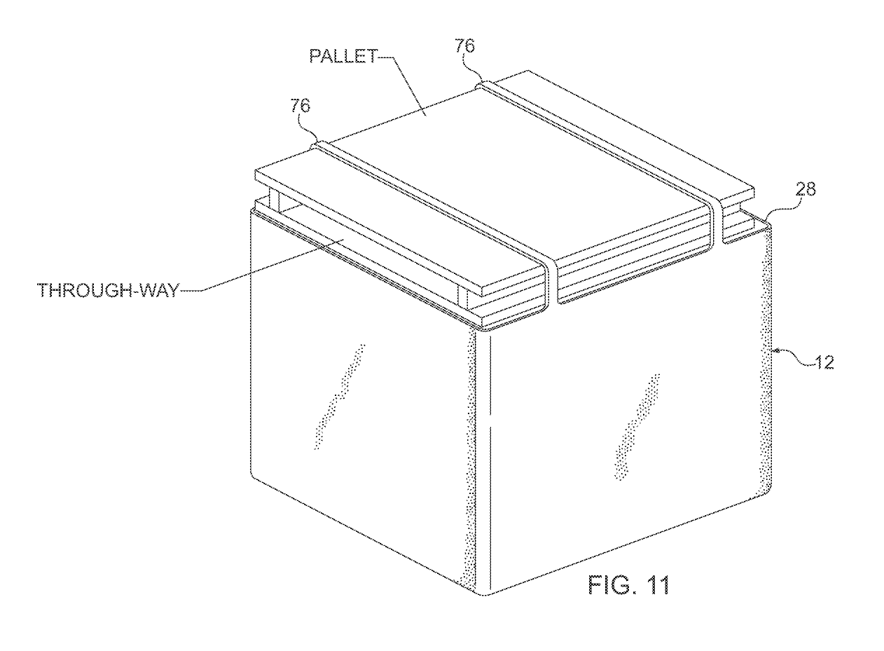

Referring now to FIG. 11, the bag 12 with loops 76 connected to the top 28 of the bag 12 and spanning from one sidewall 16, 18, 20, 22 to a subtending sidewall 16, 18, 20, 22 is disclosed.

In a further embodiment, at least one loop 76 may span from a sidewall 16, 18, 20, 22 to a subtending sidewall 16, 18, 20, 22, thus arch over the open top 28 of the bag 12. In this embodiment, the forklift tines may be inserted underneath the loops 76 to hoist the bag 12. Furthermore, a pallet or other lift-supporting member (e.g., pipes, guide channels, etc.) may be inserted between the loops 76 and the top 28 of the bag 12. In this way, the loops 76 are routed over the lift-support member and the through-ways of the lift-support member are accessible for forklift tines to be inserted therein. In this embodiment, the lift-supporting member may be left within the loops 76 as the bag 12 is stacked and/or handled.

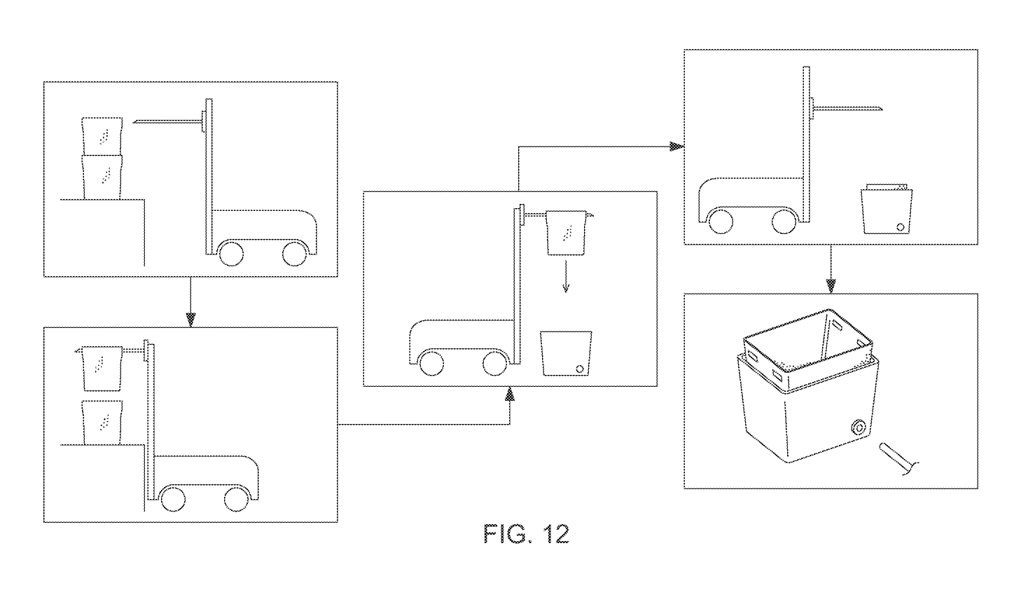

Referring now to FIG. 12, an exemplary method of using the bag 12 with through-holes 26 is disclosed.

In use, the apparatus may be employed by: engaging the bag 12 with a forklift, via a forklift operator, by inserting at least one forklift tine of the forklift through at least one through-hole 26 formed in an upper portion 32 of the bag 12 to lift the bag 12 with at least one forklift tine of the forklift and suspend the bag 12 from the at least one forklift tine without the forklift operator interrupting operation of the forklift to rig the bag 12 to the forklift and without rigging by a rigging operator for the engaging; transporting the bag 12, by the forklift, to a dispensing unit; lowering, by the forklift, the bag 12 into the dispensing unit; disengaging the bag 12 from the forklift, via the forklift operator, by extracting the least one forklift tine of the forklift from the at least one through-hole 26 without the forklift operator interrupting operation of the forklift and without activity by the rigging operator for the disengaging; and, piercing the bag 12 with a piercing object, extracting material held within the bag 12.

In further embodiments, lowering the bag 12 into the dispensing unit may include lowering the bag 12 into a hopper of the dispensing unit, seating the bag 12 within the hopper without interference caused by the forklift tines making contact with the hopper. Piercing the bag 12 may include using a lance of a lance assembly as the piercing object, and extracting material held within the bag 12 may include at least one of fluidizing the material via compressed air supplied through the lance assembly and drawing the material via suction supplied through the lance assembly. Piercing the bag 12 with the piercing object may include penetrating the bag 12 through a lance aperture 62, and further include penetrating at least one of a liner and a sacrificial flap 64 positioned within the bag 12.

Further embodiments may include removing the bag 12 from the dispensing unit by re-engaging the bag 12 with the forklift, via the forklift operator, by inserting the at least one forklift tine of the forklift through the at least one through-hole 26 formed in an upper portion 32 of the bag 12 to lift the bag 12 with the at least one forklift tine from within the dispensing unit without the forklift operator interrupting operation of the forklift and without rigging by the rigging operator for the engaging.

At least one of the engaging the bag 12 with a forklift, the disengaging the bag 12 from the forklift, and the re-engaging the bag 12 with the forklift comprises sliding the at least one forklift tine through at least one through-hole 26 of the bag 12, sliding the at least one forklift tine through a through-hole pair 40, 42, and/or sliding the at least one forklift tine through an enclosed corridor 44 of the through-hole pair 40, 42.

Further embodiments may include engaging the bag 12 with the forklift from a stacked position. The stacked position may include a first bag 12 placed beneath a second bag 12 such that a bottom 36 of the second bag 12 fits within an open top 28 of the first bag 12 and rests upon the material within the first bag 12 or the top-cover 13 of the first bag 12 without deforming an upper portion 32 of the first bag 12.

Further embodiments may include inserting a through-hole insert 46 in at least one through-hole 26 before engaging the bag 12 with the forklift.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

1-20. (canceled)

21. A method for handling a bag, comprising:
transporting the bag with a hoisting machine from a storage area to a dispensing unit;
lowering, by the hoisting machine, the bag into the dispensing unit;
piercing the bag with a piercing lance by inserting the piercing lance through a port of the dispensing unit and further through a portion of the bag;
extracting material held within the bag through the piercing lance.

22. The method recited in claim 21, wherein the dispensing unit comprises a hopper structure configured to receive at least a bottom portion of the bag.

23. The method recited in claim 21, wherein the extracting material held within the bag includes at least one of fluidizing the material via compressed air supplied through a lance assembly of the piecing lance and drawing the material via suction supplied through the lance assembly.

24. A method for handling a bag, comprising:
engaging the bag with a hoisting machine, via hoisting operator, by inserting a hoist-member of the hoisting machine through at least one through-hole formed in an upper portion of the bag to lift the bag with the hoist-member of the hoisting machine and suspend the bag from the hoist-member without the hoisting operator interrupting operation of the hoisting machine to rig the bag to the hoist machine and without rigging by a rigging operator for the engaging;
transporting the bag, by the hoisting machine, to a dispensing unit;
lowering, by the hoisting machine, the bag into the dispensing unit;
disengaging the bag from the hoisting machine, via the hoisting operator, by extracting the hoist-member of the hoisting machine from the at least one through-hole without the hoisting operator interrupting operation of the hoisting machine and without activity by the rigging operator for the disengaging;
piercing the bag with a piercing object by inserting the piercing object through both a port of the dispensing unit and a sidewall or base of the bag; and,
extracting material held within the bag.

25. The method recited in claim 24, further comprising inserting a through-hole insert in at least one through-hole before engaging the bag with the hoisting machine.

26. The method recited in claim 24, wherein the extracting material held within the bag includes at least one of fluidizing the material via compressed air supplied through a lance assembly and drawing the material via suction supplied through the lance assembly.

27. The method recited in claim 24, wherein the piercing the bag with the piercing object further comprises penetrating the bag through a lance aperture.

28. The method recited in claim 27, wherein the piercing the bag with the piercing object further comprises penetrating at least one of a liner and a sacrificial flap positioned within the bag.

29. The method recited in claim 24, further comprising removing the bag from the dispensing unit by re-engaging the bag with the hoisting machine, via the hoisting operator, by inserting the hoist-member of the hoisting machine through the at least one through-hole formed in the upper portion of the bag to lift the bag with the hoist-member from within the dispensing unit without the hoisting operator interrupting operation of the hoisting machine to rig the bag to the hoist machine and without rigging by the rigging operator for the re-engaging.

30. A method for handling a bag, comprising:
engaging the bag with a forklift, via a forklift operator, by inserting at least one forklift tine of the forklift through at least one through-hole formed in an upper portion of the bag to lift the bag with the at least one forklift tine of the forklift and suspend the bag from the at least one forklift tine without the forklift operator interrupting operation of the forklift to rig the bag to the forklift and without rigging by a rigging operator for the engaging;
transporting the bag, by the forklift, to a dispensing unit;
lowering, by the forklift, the bag into the dispensing unit;
disengaging the bag from the forklift, via the forklift operator, by extracting the least one forklift tine of the forklift from the at least one through-hole without the forklift operator interrupting operation of the forklift and without activity by the rigging operator for the disengaging;
piercing the bag with a piercing object by inserting the piercing object through a port of the dispensing unit and further into a cavity of the bag; and,
extracting material held within the bag.

31. The method recited in claim 30, wherein the lowering the bag into the dispensing unit further comprises lowering the bag into a hopper portion of the dispensing unit, seating the bag within the hopper portion without interference caused by the forklift tines making contact with the hopper.

32. The method recited in claim 30, wherein piercing the bag comprises using a lance of a lance assembly as the piercing object.

33. The method recited in claim 32, wherein the extracting material held within the bag includes at least one of fluidizing the material via compressed air supplied through the lance assembly and drawing the material via suction supplied through the lance assembly.

34. The method recited in claim 30, wherein the piercing the bag with the piercing object further comprises penetrating the bag through a lance aperture.

35. The method recited in claim 34, wherein the piercing the bag with the piercing object further comprises penetrating at least one of a liner and a sacrificial flap positioned within the bag.

36. The method recited in claim 30, further comprising removing the bag from the dispensing unit by re-engaging the bag with the forklift, via the forklift operator, by inserting the at least one forklift tine of the forklift through the at least one through-hole formed in an upper portion of the bag to lift the bag with the at least one forklift tine from within the dispensing unit without the forklift operator interrupting operation of the forklift to rig the bag to the forklift and without rigging by the rigging operator for the re-engaging.

37. The method recited in claim 36, wherein at least one of the engaging the bag with a forklift, the disengaging the bag from the forklift, and the re-engaging the bag with the forklift comprises sliding the at least one forklift tine through a through-hole pair.

38. The method recited in claim 36, wherein at least one of the engaging the bag with a forklift, the disengaging the bag from the forklift, and the re-engaging the bag with the forklift comprises sliding the at least one forklift tine through an enclosed corridor of the through-hole pair.

39. The method recited in claim 30, further comprising engaging the bag with the forklift from a stacked position, wherein the stacked position comprises a first bag placed beneath a second bag such that a bottom of the second bag fits within an open top of the first bag and rests upon at least one of the material within the first bag and a top-cover of the first bag without deforming an upper portion of the first bag.

40. The method recited in claim 30, further comprising inserting a through-hole insert in at least one through-hole before engaging the bag with the forklift.
